(19) United States
(12) Patent Application Publication
(10) Pub. No.: US 2011/0102585 A1
(43) Pub. Date: May 5, 2011

(54) SURVEILLANCE DEVICE FOR POWER LINE PEER-TO-PEER SIGNAL TRANSMISSION

(76) Inventor: Yu-Li KAO, Yonghe City (TW)

(21) Appl. No.: 12/611,657

(22) Filed: Nov. 3, 2009

(51) Int. Cl. H04N 7/18

(52) U.S. Cl. 348/143; 348/E07.085

(57) ABSTRACT

A surveillance device for power line peer-to-peer signal transmission includes a photographing device, a surveillance device and a peer-to-peer server. The photographing device includes a power line network bridge and a first router, and can be connected to internet through the first router, the power line network bridge and a power line. The surveillance device includes a second router and is connected to internet through the second router. The peer-to-peer server connects the first router with the second router through internet. By the aforementioned structures, an ordinary person can easily monitor and control images and electric equipment at home through internet, without carrying out a network wiring or knowing how to set up an IP.

### BACKGROUND OF THE INVENTION

a) Field of the Invention

The present invention relates to a network image surveillance and equipment control system, and more particularly to a surveillance device for power line peer-to-peer signal transmission, which utilizes a power line network to connect a network and applies a peer-to-peer technology to carry out signal transmission.

b) Description of the Prior Art

As advancement of technology and popularity of internet, a user is able to install a photographing device at a place to be monitored in advance, then monitor at any time images of an IP (Internet Protocol) camera through internet, and at a mean time, control electric equipment and receive an alarm signal detected by alarm equipment. This application actually has brought convenience in living to fight crimes and secure evidences.

However, when the aforementioned surveillance and photographing equipment is used, following issues and shortcomings actually exist to be improved:
1. If the conventional photographing device is an IP camera, then network wiring is required, which not only wastes time and labor works, but also costs a lot.
2. If the conventional photographing device is an IP camera, then connection can only be made through internet after a complicated network IP setup, and this cannot be easily done by an ordinary user.

Accordingly, how to solve the aforementioned issues and shortcomings of the prior art is a direction of research and development for improvement by the present inventor and related vendors.

### SUMMARY OF THE INVENTION

The primary object of the present invention is to provide a surveillance device which uses a power line network to connect a network and applies a peer-to-peer technology to conduct signal transmission.

To achieve the aforementioned object, the surveillance photographing device of the present invention includes a photographing device, a surveillance device and a peer-to-peer server. The photographing device includes a power line network bridge and a first router, and can be connected to internet through the first router, the power line network bridge and a first power line. The surveillance device includes a second router and is connected to internet through the second router. The peer-to-peer server connects the first router and the second router through internet.

In general, the user must accomplish the time and labor works consuming network wiring and complicated IP setup that images of the IP camera can be seen or electric equipment can be controlled, through internet. As the photographing device of the present invention includes the power line network bridge, the user can use a PLC (Power Line Communication) technology to save a trouble of network wiring. In addition, as the present invention includes the peer-to-peer server, a P2P (Peer to Peer) technology can be used to avoid setting up an IP. As a result, an ordinary person does not need to do the network wiring, or to know how to set up an IP. On the other hand, the surveillance device of the present invention can be a mobile phone or a computer and the user just only uses the computer or the mobile phone that he or she can easily monitor images at home or control the electric equipment, and at a same time, receive the alarm signal detected by the alarm equipment, through internet.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a preferred embodiment of the present invention.

FIG. 2 shows a schematic view of an implementation of the preferred embodiment of the present invention.

### DETAILED DESCRIPTION OF THE PREFERRED EMBODIMENTS

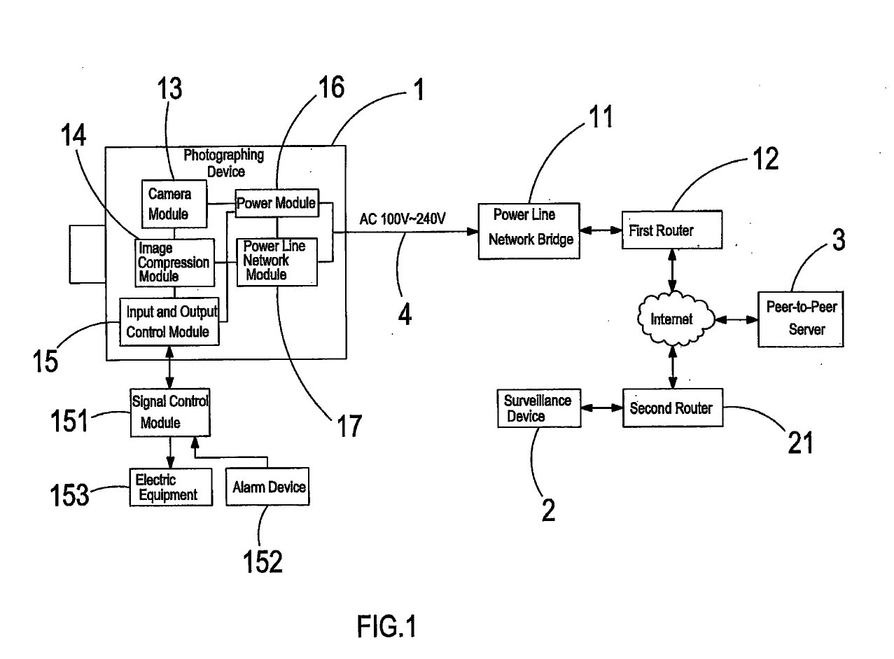

Referring to FIG. 1, it shows a block diagram of a preferred embodiment of the present invention. As shown in the drawing, the present invention comprises a photographing device 1, a surveillance device 2 and a peer-to-peer server 3.

The photographing device 1 includes a power line network bridge 11 and a first router 12 and can be connected to internet through the first router 12, the power line network bridge 11 and a power line 4. An interior of the photographing device 1 is provided with a storage device, such as a hard drive or a memory, such that when image files are recorded by the photographing device 1, the image files can be saved in the storage device. In addition, the interior of the photographing device 1 also includes a camera module 13, an image compression module 14, an input and output control module 15, a power module 16 and a power line network module 17, to accomplish photographing and transmission functions. The input and output control module 15 can be further connected with a signal control module 151 which is connected respectively with an alarm device 152 and electric equipment 153; whereas, the photographing device 1 is an IP camera.

The surveillance device 2 includes a second router 21 and can be connected to internet through the second router 21. The surveillance device 2 can be a computer or a mobile phone and can be located at a central control center or a monitoring station; therefore, by watching the surveillance device 2, the user can look at the images that are recorded by the photographing device 1.

The peer-to-peer server 3 can connect the first router 12 with the second router 21 through internet.

The photographing device 1 and the surveillance device 2 utilize a hole punching technology to carry out peer-to-peer transmission through the first router 12 and the second router 21, by the peer-to-peer server 3.

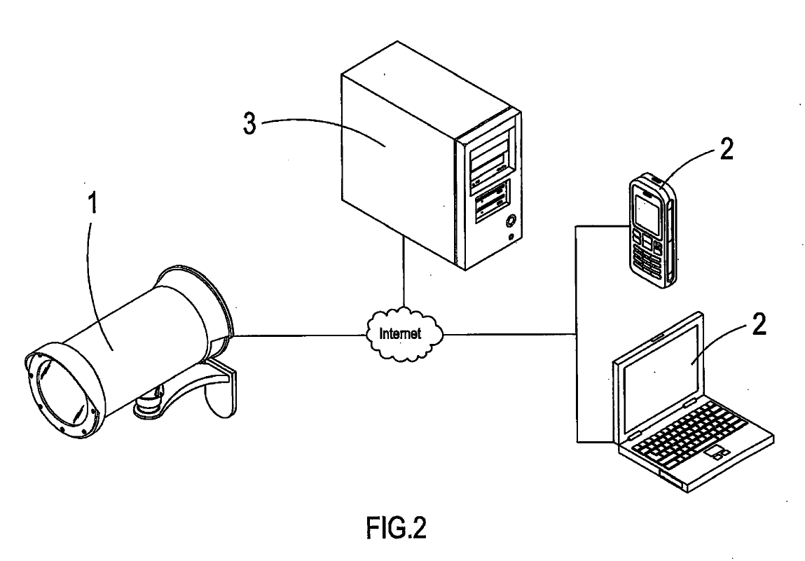

Referring to FIG. 1 and FIG. 2, it shows the block diagram and a schematic view of an implementation, of the preferred embodiment of the present invention. As shown in the drawings, when the photographing device 1 of the present invention is connected to internet, images are first recorded by the camera module 13 of the photographing device 1. After recording, image signals will be transmitted by the camera module 13 to the image compression module 14 to compress into digital image signals. Next, the digital image signals are transmitted through the power line network module 17 and the power line 4 (AC 100V˜240V) to the power line network bridge 11 and connected to Internet through the first router 12. These are the processes that the photographing device 1 is connected to internet.

After being connected to internet, the photographing device 1 is automatically connected to the peer-to-peer server 3 which will make a hole punching to the first router 12 that is connected with the photographing device 1. On the other hand, after being connected to internet, the surveillance device 2 is also automatically connected to the peer-to-peer server 3 which will make a hole punching to the second router 21 that is connected with the surveillance device 2. At this time, the photographing device 1 can transmit the image signals to the surveillance device 2 without going through the peer-to-peer server 3.

After the photographing device 1 has been connected to the surveillance device 2, the surveillance device 2 (e.g., a computer or a mobile phone) can control the connected electric equipment 153 and receive the signals that are transmitted from the alarm device 152 to provide an alarm effect, through the signal control module 151. Whereas, the user can monitor the images shot by the photographing device 1 at any time through the computer or the mobile phone.

Referring to all the drawings, the present invention is actually provided with following advantages when compared with the prior art.

By the aforementioned structures, an ordinary person does not need to do the network wiring or to know how to set up a network IP. In addition, the surveillance device 2 of the present invention can be a computer or a mobile phone. Therefore, the user can use the computer or the mobile phone to monitor at any time, such that he or she can easily monitor and control the images and the electric equipment 153 at home through internet.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A surveillance device for power line peer-to-peer signal transmission, comprising:
a photographing device which includes a power line network bridge and a first router, and is connected to internet through the first router, the power line network bridge and a power line;
a surveillance device which includes a second router and is connected to internet through the second router; and
a peer-to-peer server which connects the first router with the second router through internet;
wherein, the photographing device and the surveillance device carry out peer-to-peer transmission through the first router and the second router, by the peer-to-peer server.

2. The surveillance device for power line peer-to-peer signal transmission according to claim 1, wherein the first router and the second router utilize a hole punching technology to carry out peer-to-peer transmission.

3. The surveillance device for power line peer-to-peer signal transmission according to claim 1, wherein the photographing device is an IP (Internet Protocol) camera.

4. The surveillance device for power line peer-to-peer signal transmission according to claim 1, wherein the photographing device includes a camera module, an image compression module, an input and output control module, a power module and a power line network module.

5. The surveillance device for power line peer-to-peer signal transmission according to claim 4, wherein the input and output control module is further connected with a signal control module which is connected respectively to an alarm device and electric equipment.

6. The surveillance device for power line peer-to-peer signal transmission according to claim 1, wherein the surveillance device is a computer or a mobile phone.
